(19) United States
(12) Patent Application Publication
(10) Pub. No.: US 2025/0392481 A1
(43) Pub. Date: Dec. 25, 2025

(54) IMPROVED STABILITY PUF METHOD AND APPARATUS

(71) Applicant: TELEFONAKTIEBOLAGET LM ERICSSON (PUBL), STOCKHOLM (SE)

(72) Inventors: Niklas Lindskog, Lund (SE); Håkan Englund, Lund (SE); Elena Dubrova, Sollentuna (SE)

(21) Appl. No.: 18/881,323

(22) PCT Filed: Jul. 4, 2022
(86) PCT No.: PCT/IB2022/056184

§ 371 Date: Jan. 6, 2025

(51) Int. Cl. H04L 9/32; H04L 9/08

(52) U.S. Cl. CPC H04L 9/3278; H04L 9/0866

(57) ABSTRACT

According to an aspect, there is provided a method of using physically unclonable functions, PUF. The method comprises determining a response (385) from each of a plurality of PUFs (105, 110-1, 110-2, 110-N), to a set of predetermined challenges (380) applied to each said PUF (650), the set of predetermined challenges including different challenges; and generating an output (390) to each of the set of predetermined challenges using the responses (355) from the plurality of PUFs (660) and a majority decision algorithm.

### TECHNICAL FIELD

This disclosure relates to the use of PUF for authentication, identification, generation of cryptographic keys and other applications.

### BACKGROUND

Physically Unclonable Functions (PUF) may be used as part of a security apparatus or method for an electronic device that may be able to communicate over a wired or wireless communications network, such as an Internet of Things (IoT) device. PUFs are used to create a unique response by using implicit or explicit randomness in their physical structure. Explicit randomness refers to differences that are not an inherent consequence of manufacturing but are deliberately introduced at a later stage. Implicit randomness may include unpredictable manufacturing differences in, for example, semiconductor devices that can be exploited to create a device-unique response.

Two identical PUF implementations on different devices/components may result in different responses when fed the same challenges. Hence, the “unclonable” in Physically Unclonable Function. A PUF can consist of one or several subfunctions, each contributes with a part of the PUF response. Examples of subfunctions may include:
Ring-oscillators, an uneven number of signal inverters in a ring which uses gate delay propagation as randomness source. The response is a comparison between two or more ring-oscillators where the number of oscillations at a given point is measured. The result can e.g., be the identifier of the fastest/slowest ring oscillator.
Uninitialized SRAM memory cells, which have two possible states (0 and 1). Prior to power up, the cell is in neither state. At powerup, the cell stabilizes in one of the two states. The response is the entered state.
An arbiter, which might be regarded as a digital race condition between two or more signal paths on a chip where a so-called arbiter circuit identifies the winning signal. The paths might comprise several switch blocks, which can alter the signal paths. For example, the PUF response can be an identification of the winning signal.

A PUF response can be used for cryptographic or identity purposes such as creating a unique device identity or a device unique key, without having to store the key or identity on the device where it may be susceptible to discovery or attack.

The PUF response can be used to create a unique device identity or a device unique key, without having to store the key on the device, for example in a Battery Backed RAM (BBRAM) or One Time Programmable (OTP) memory. Hence, it is much harder for an attacker steal a key from a device using a PUF, as the key is never stored on device.

Many different types of PUF exist and the different types may be categories according to performance, physical structure, etc. Challenge-response type PUFs require input to trigger the PUF response. There challenge-response PUF may be divided into two categories, those capable of one or a small number of challenge response pairs (CRPs), and those having a large set of CRPs. The latter can produce several different responses by using different challenges as input. The former only allows one or a few challenges. If the PUF only accepts a single challenge, the challenge may be hard-coded or omitted.

Most PUF types additionally require error correcting codes (often denoted as helper data) to function properly; to increase the possibility of recreating the same response given the same challenge. This is because whilst a PUF generally provides the same response to the same challenge, occasionally errors may occur, and the helper data or correcting codes are used to correct for these occasional errors.

U.S. Pat. No. 10,230,369 describes a hardware embedded delay PUF (HELP) and a method to increase the stability of the PUF. It does this by finding a pattern of responses repeating a first generated pattern of responses within all possible patterns of responses generated by a specific PUF. The HELP PUF generates a response and selects bits in the response which produce the same pattern. However, due to the PUF elements not taking input (i.e. challenges), it is only applicable to non-challenge-response types of PUFs.

An approach to improving the stability of a challenge-response type of PUF is described in “Secure and Reliable XOR Arbiter PUF Design: An experimental study based on 1 Trillion Challenge Response Pair Measurements” by Chen Zhou, Keshab K. Parhi, Chris H. Kim. This describes finding stable responses for a challenge in an XOR PUF. A PUF construction comprising several PUF's which outputs are XOR: ed to make PUF modelling difficult. The XOR-PUF has a stability enhancing enrollment procedure where the individual response to a challenge is measured for each PUF. Only challenges which produce stable responses for all PUF's are selected as “allowed challenges”.

### SUMMARY

In one aspect there is provided a method of using physically unclonable functions, PUFs. The method comprises determining a response from each of a plurality of PUFs to a set of predetermined challenges applied to each said PUF, the set of predetermined challenges including different challenges; and generating an output to each of the set of predetermined challenges using the responses from the plurality of PUFs and a majority or a minority decision algorithm.

In another aspect there is provided a method of using physically unclonable functions, PUFs. The method comprises determining a response from each of a plurality of PUFs responsive to a candidate challenge applied to each said PUF; and associating the candidate challenge with the plurality of PUFs responsive to the responses from the plurality of PUFs meeting a predetermined pattern.

Such methods advantageously enhance the ability of a PUFs based apparatus to generate an expected output to a given challenge, even if even if a minority of the responses are erroneous. This is achieved without the need for helper data which bring large overheads in terms of area, power consumption, latency and increased security risk. The methods enhance the likelihood that only the “correct” output is produced by masking faults. The methods therefore improve the reliability an error tolerance of PUF-based arrangements, irrespective of the PUF type used.

According to certain embodiments described herein there are also provided corresponding nodes, systems and apparatus. There is also provided a computer program comprising instructions which, when executed on a processor, causes the processor to carry out the methods described herein. The computer program may be stored on a non-transitory computer readable media.

Those skilled in the art will be aware of other benefits and advantages of the techniques described herein.

### BRIEF DESCRIPTION OF THE DRAWINGS

Some of the embodiments contemplated herein will now be described more fully with reference to the accompanying drawings, in which:

FIG. 1 is a schematic of an apparatus comprising a plurality of PUFs and according to an embodiment;

FIG. 2 is a schematic illustrating operation of the apparatus of FIG. 1 during an enrollment procedure and according to an embodiment;

FIG. 3 is a schematic illustrating operation of the apparatus of FIG. 1 during a recreation procedure and according to an embodiment;

FIG. 4 illustrates a method of enrolling challenge-response pairs for a security apparatus according to an embodiment;

FIG. 5 illustrates a method of generating responses to challenges in a security apparatus according to an embodiment; and

FIG. 6 illustrates a security apparatus according to an embodiment.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions. Memory may be employed to storing temporary variables, holding and transfer of data between processes, non-volatile configuration settings, standard messaging formats and the like. Any suitable form of volatile memory and non-volatile storage may be employed including Random Access Memory (RAM) implemented as Metal Oxide Semiconductors (MOS) or Integrated Circuits (IC), and storage implemented as hard disk drives and flash memory.

Embodiments described herein relate to methods and apparatus for improving the stability of a PUF based security component for use in a communicating device such as an IoT device. A plurality of parallel PUFs are employed to which a set of predetermined challenges are applied. The same challenge is applied to each PUF and the responses post-processed to generate a stable output. The next challenge in the set of predetermined challenges is then applied and the responses again post-processed to generate the next output. The predetermined challenges may correspond to an initial enrolment phase where various candidate challenges are applied to the plurality of PUF and selected depending on whether the responses of the PUFs correspond to a predetermined pattern. When generating outputs, a majority or minority voting algorithm is applied to the responses which masks any occasional error in the one or two of the PUF using N modular redundancy. A more stable challenge-response PUF arrangement is thereby provided.

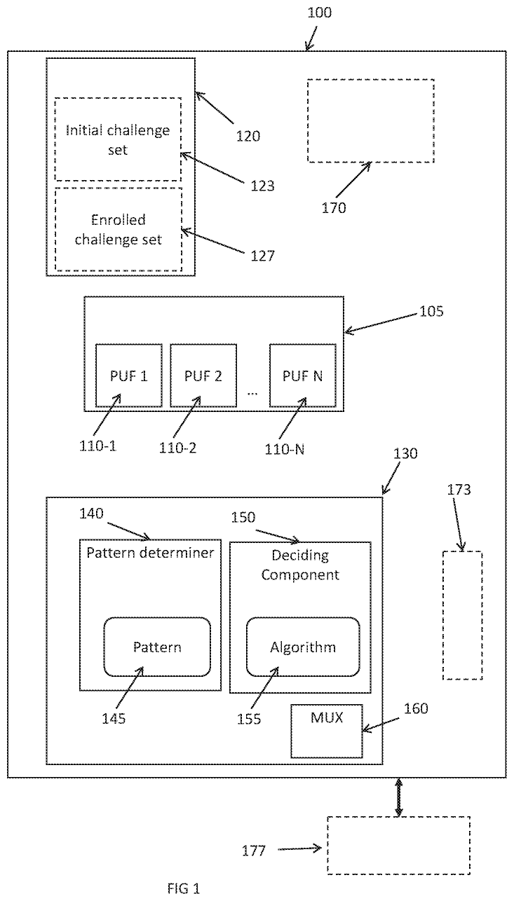

FIG. 1 illustrates an apparatus comprising a plurality of PUFs according to an embodiment. The apparatus 100 comprises a plurality of PUFs 105, the PUF 110-1, 110-2, 110-N may be of the same of different types. Example PUF types include ring-oscillators, uninitialized SRAM memory cells, and digital race condition arbiters, although any suitable hardware may be employed. Each PUF 110-1 will normally respond to a particular challenge in the same way, each time that challenge is presented. A different PUF 110-2 will also respond in the same way to that challenge, although the response may be different than that of the first PUF 110-1. Each PUF may therefore be defined by respective sets of challenge response pairs (CRPs), the responses being unpredictable but the same for each PUF for each challenge. However, occasionally a response may include an error. Many different response types are possible depending on the type of PUF. For example, a challenge may comprise a sequence of bits being applied to the PUF which responds with a single bit. In other examples the challenges and/or responses may comprise symbols or analog physical quantities such as voltage levels.

The apparatus 100 may also comprise memory 120 as well as post-processing circuitry 130. The memory 120 may be used to store an initial challenge set 123 which may be used during an enrollment phase to enroll challenges meeting a predetermined requirement. The memory may also be used to store the enrolled challenge set. In some embodiments the initial challenge set and/or the enrolled challenge set may be stored in an external device 177 and communicated to the apparatus 100.

The apparatus may also comprise post-processing circuitry 130 which comprises a pattern determiner 140 having an associated predetermined pattern 145 and a deciding component 150 having an associated algorithm 155 for processing response from the PUF 110-1-110-N into an output. A mux 160 may be used to switch between the pattern determiner 140 and the deciding component 150 to implement an enrolment mode or a recreation mode of the apparatus. Alternatively, the post-processing circuitry 130 may only comprise one of the pattern determiner 140 or deciding component 150 at a time. For example, the pattern determiner may only be switched in during an initial enrollment phase during manufacturing. The post-processing circuitry 130 may also comprise a translation function which translates some or all of the responses from the PUFs 110-1-110-N before these are used by the pattern determiner 140 or deciding component 150. For example, where the responses are in the form of a bit, one or more of the responses may be inverted.

The predetermined pattern 145 used during enrolment may be that all the responses are the same when the same challenge is applied to each PUF. Alternatively, a pattern may be used where a predetermined number (e.g. N/2) of the total responses N are the same, and the remaining responses (N/2) are the same, albeit a different response. However, any other suitable pattern may alternatively be used. Alternatively, a pattern may be used where the Hamming weight of the total responses N is considered, that is the total number of binary 1's. Using a Hamming weight based approach is helpful for improving side-channel protection. For example, the Hamming weight could correspond to N/2 of the response bits. If there is only one response bit and N/2 (or N/2-1 if an uneven number of PUFs) has 1, then the rest of the PUFs should be 0. This provides a Hamming weight of N/2 each time. The pattern may additionally restrict the difference in Hamming weight between sets of PUFs responses. For example, given four PUFs and a total Hamming weight of 4, the pattern may further require the combined responses from PUF-1 and PUF-2 to either have a Hamming weight of at least 3 or at most 1. It is also possible to have each PUF with multi-bit responses. For example, for two bits and 4 PUFs and a total Having weight of 2 (N/2), allowable patterns include for example, 01, 11, 00, 01 and 01, 10, 10, 01.

The algorithm 155 used in the deciding component 150 may comprise a majority or minority voting function so that, for example, where a majority of the responses are 1, the output is 1. In this example, if the responses to the challenge were all expected to be 1, but an error occurs in one of the PUF producing instead a 0, because most of the responses are still 1 this is passed through as the output to the challenge.

The apparatus 100 may also comprise pre-processing circuitry 170 which may reformat a challenge to be applied to the PUF 110-1-110-N into something suitable for the type of PUF involved. For example, a series of bits may be reformatted into a voltage. The pre-processing component may be embodied as at least one of one-way function (e.g. a hash function), a lookup table (e.g. one challenge is explicitly translated to another), a PRNG (e.g. where the one challenge is used as seed which is used by the PRNG to create a random but deterministic challenge). The pre-processing component may be relevant when PUFs are of different types.

The apparatus may also comprise a register 173 to temporarily store outputs from the post-processing circuitry. For example, 256 challenges may be applied to the plurality of PUFs 105 with each output representing 1 bit of a 256 bit key which is collected in the register 173.

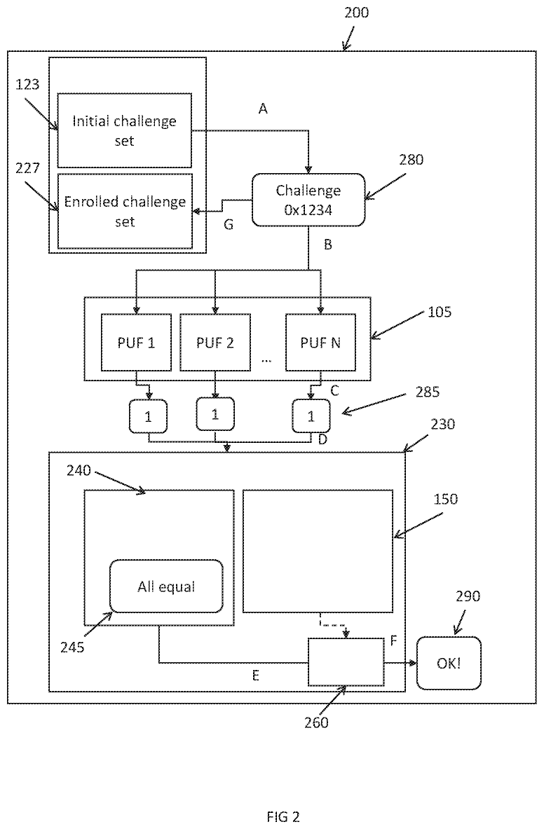

FIG. 2 illustrates an enrolment phase for an apparatus similar to that of FIG. 1. A challenge 280 from an initial set of candidate challenges 123 is applied to each of the PUF in a plurality of PUFs 105. The same challenge 280 is applied to each PUF simultaneously and each PUF generates a corresponding response 285. These responses are then input to the pattern determiner 240 to determine whether they match the predetermined pattern 245, in this case that all the responses are the same. If all of the responses are the same such that the pattern is matched, the post-processing circuitry 230 indicates success 290 which allows the candidate challenge to be added to the enrolled challenge set 227. A challenge 280 where the responses of the plurality of PUF 105 do not meet the pattern 245 is not added to the enrolled challenge set 227. Candidate challenges continue to be applied until a sufficient number, for example 256, challenges are included in the enrolled challenge set 227.

Thus in the case where the determined pattern is all responses are the same, for a challenge C, the challenge should fulfil R₁(C)=R₂(C)= . . . =R_{N}(C), where Rᵢ(C) stands for the response of the PUF i to the challenge C, for all i in {1, 2, . . . ,N}. The selection of challenges can be done, for example, by choosing C at random from the set of possible challenges where the post-processing components checks if R₁(C)=R₂(C)= . . . =R_{N}(C).

In an alternative arrangement, the pattern may be N/2 of the N responses are the same, or N/2+1 of the responses are the same when N is odd. This pattern reduces side-channel leakage which can be defined as a non-intended information channels and may consist of power consumption, electromagnetic (EM) emissions, thermal signatures and optical emissions. An attacker can utilize these leakages to extract sensitive information from a device to extract a key utilized to encrypt information. Redundancy can make power and EM-based side-channel analysis easier. This is because the duplication of components increases the switching activity (since more than one component is switching from one logic value to another at the same time), resulting in a higher dynamic power consumption and EM radiation, thus increasing the side-channel leakage.

By using a pattern which always produces the same number of 1s and 0s, or similar for an odd N, less information is provided to a hacker than an all equal pattern. Side-channel attacks which use the Hamming weight of the state (the response vector in PUF's case) as a power model can be mitigated by implementing one half of the redundant components in the complementary form, so that they evaluate to ‘0’ whenever the other half of the redundant components evaluate to ‘1’, and vice versa. This makes the Hamming weight of the state (response) constant. By ensuring that the PUF always outputs the combined Hamming weight of N/2, the side-channel leakage from the PUF is significantly reduced.

In one embodiment, a challenge may be successfully enrolled only when it reproduces the predetermined pattern upon multiple applications to the plurality of PUFs 105. Furthermore, when retrying these challenges, the apparatus may apply different voltages and/or change the temperature of the PUFs 105 to ensure the challenge remains pattern matching for all environmental conditions.

The apparatus may perform re-enrollment after the initial enrollment. This may be performed to produce an entirely new pattern-matching challenge set which can then be used to create a new output sequence from the post-processing circuitry. This may be used to erase a previously used cryptographic key and replace it with a new one. Re-enrollment may also be performed to evaluate the old pattern-matching or enrolled challenge set and determine if any challenges are no longer fulfilling the pattern. In this case, new challenges can be selected which replace challenges not fulfilling the pattern. This may be useful to ensure the enrolled challenge set remains viable over time where changes in the apparatus circuitry may affect some PUF.

In another embodiment, in the enrollment phase, combinations of challenges which results in a collision in the outputs of the PUFs may be identified. For example, for three PUFs with the pattern “all same”, and one challenge applied to all three PUFs, where two of the PUFs response in the same way but the third does not, instead of trying another challenge for all three PUFs, a new challenge is applied to the third PUF until it responds in the same way as the other two PUF did with the original challenge. This increases the number of challenges stored to recreate the pattern, but this reduces the number of attempts to perform a successful enrollment. As collisions are likely to be found using only 2^{N/2} or m^{N/2} search space these are faster to find, on the other hand the storage space required is larger. In the recreation phase, all challenges are used.

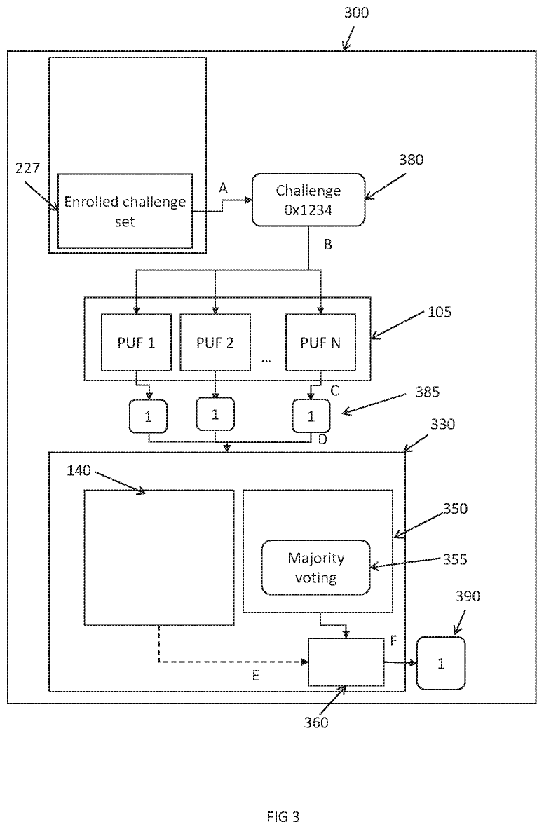

FIG. 3 illustrates a recreation phase for an apparatus similar to that of FIG. 1. A challenge 380 is retrieved from the enrolled challenge set 227 and is applied in parallel to each PUF of the plurality of PUFs 105. This results in respective responses from each PUF which are then applied to the pattern determiner 350. The algorithm 355 used in this embodiment is majority voting which is applied to the responses to generate an output 390. A sequence of enrolled challenges 227 may be applied in order to generate a sequence of outputs 390 which may then be used for a cryptographic key or identifier for a device comprising the security apparatus 300.

In the case where the enrolment pattern used was N/2 of the responses being the same, half of the responses are inverted before applying the algorithm 355. For example, in an embodiment with 4 PUF's, each producing 1 bit output for each challenge, the pattern could be “1 1 0 0” or “0 0 1 1”. The deciding algorithm would then be instructed to perform a majority decision with an inversion on two of the PUF responses:

$$Output = MAJ ( ¬ ( {R}_{PUF 1} ) , ¬ ( {R}_{PUF 2} ) , {R}_{PUF 3} , {R}_{PUF 4} )$$

In the case where the enrolment pattern has a specific Hamming weight, e.g., m*(N/2), where m is the number of bits in the PUF's response, the output may be decided by dividing the PUF's into two sets and comparing each set's combined responses. The deciding algorithm would then be instructed to perform a majority decision on both sets. The output may in this case be the identifier of the set with the highest Hamming weight. So for example, a first set of PUFs A has three out of four binary “1” responses and a second set B has one out of four binary “1” responses. If each set A and B get one vote for each “1”, then A wins and the output reflects that A has received most votes. To further exemplify, the output may be “1” when A wins and “0” when B wins.

By ensuring that the PUFs always outputs the combined Hamming weight of N/2, the side-channel leakage from the PUF is significantly reduced. It does not matter which responses are inverted, so long as this is predetermined.

As noted previously, the same or different PUF types may be employed. For example, the invention may use N/2 arbiter PUFs and N/2 ring-oscillator PUFs. This may be used to avoid common-mode faults and to require an attacker to master several different technologies to successfully attack the device.

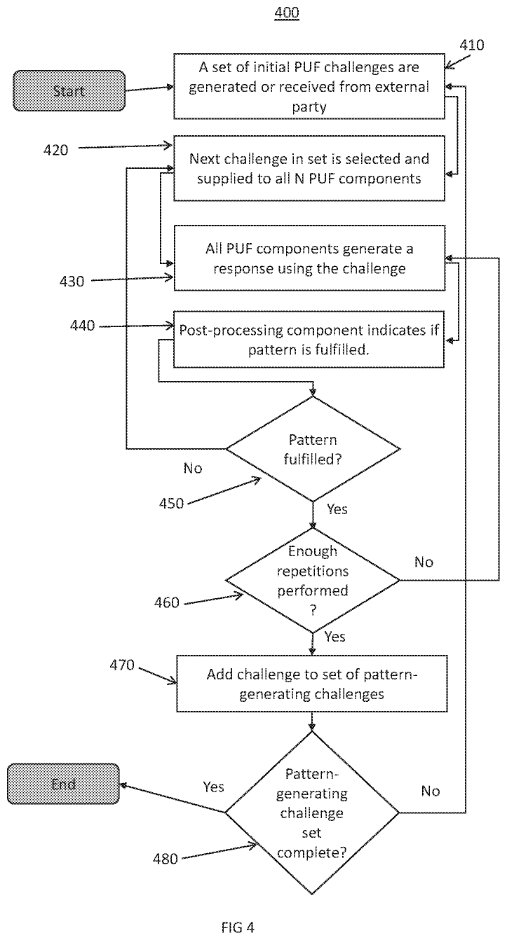

FIG. 4 illustrates a method of generating a predetermined or enrolled set of challenges for a plurality of PUFs. The method 400 may be implemented by any suitable apparatus such as the apparatus 100 of FIG. 1, however it may be implemented by a different apparatus or device.

At 410, a set of initial PUF challenges are generated or retrieved. This initial set may be stored locally on the apparatus, generated locally on the apparatus or retrieved from an external device or party. Any suitable method of generating the challenges may be used, for example using a TRNG (True Random Number Generator) to generate random numbers and optionally using the these as a seed to a PRNG (Pseudo Random Number Generator) or as a parameter to an OWF (one way function). The output from TRNG, PRNG or OWF may then be used, and converted if necessary, for applying to the PUFs as challenges.

At 420, a first/next challenge in the initial set is selected and applied to all N PUF components in the plurality of PUF. The selected challenge is applied in parallel and simultaneously to the PUFs. Each challenge may be 64-128 bits which are applied to each PUF. Alternatively different types of challenges may be employed such as symbols or analog physical values such as voltage. The PUF may be of the same or different types which may assist with suppressing common mode errors.

At 430, the PUFs each generate a response to the applied challenge according to their respective challenge response pair (CRP). The response may be one or more bits, a symbol or an analog physical value.

At 440, the method determines whether the responses of all the PUFs match a pattern. This may be implemented using post-processing circuitry. Example patterns are all responses are the same or half the responses are the same. For example, for N=4, assuming one bit responses, the responses match an “all equal” pattern when the responses are “1, 1, 1, 1” or “0, 0, 0, 0”. The responses match a half equal pattern when “1, 1, 0, 0” or “0, 0, 1, 1”. In another example where N is odd, for N=5 the pattern may be (N−1)/2 responses has a specific Hamming weight, such as 2 or 3, in which case the following patterns match: “1, 1, 0, 1, 0”; “1, 0, 1, 0, 0”; “1, 0, 0, 1, 1”; “0, 0, 0, 1, 1”; “0, 1, 0, 0, 1”; “1, 0, 1, 0, 1”. In another example the pattern may be (N−1)/2 responses are equal.

In some embodiments, translations may be introduced to some or all of the responses before determining whether the pattern is matched. For example, some inputs may be inverted which may be helpful in avoiding side channel leakage. In one example, it might be expected that all of the PUF might respond in the same way (e.g. “1”) to a particular challenge. By inverting half of the responses, the responses may then meet a pattern where half the responses are equal.

If the PUF responses, translated or untranslated, do is not meet the predetermined pattern, then at 450-No, then method returns to 420 where the next challenge is applied to the PUFs. If the PUF responses do meet the predetermined pattern, then at 450-Yes then method moves to 460 where it checks for whether enough repetitions have been performed for the challenge. By applying the same challenge to the plurality of PUFs multiple times and checking whether the responses always met the pattern, this implies a stable CRP which is more likely to keep responding in the same way to the challenge over time; for example even as some environmental factors change. If not enough repetitions have been performed, the method at 460-No returns to 430 when the responses are checked again against the predetermined response. If they no longer match, the method will move onto the next challenge. If however the responses again match the pattern, the method will again return to 460 until enough repetitions have been performed. Once enough repetitions have been performed, at 460-Yes the method moves to 470.

At 470, the method adds the challenge response pair to an enrolled set of challenges. The enrolled set corresponds to a set of predetermined challenges that may be used with the plurality of PUFs to generate stable responses which can be used together with a simple error correcting technique to ensure a reliable output to the application of various combinations of these predetermined challenges.

At 480, the method determines whether the pattern generating challenge set is complete. For example, if the enrolled set is needed to generate a 256 key, then the method will continue until the enrolled set comprises 256 challenges. If not enough challenges have been enrolled, then at 470-No the method returns to 410 or 420 when a new challenge is selected form a previously generated or stored set or additional challenges are obtained. If enough challenges have been enrolled, then at 480-Yes the method ends.

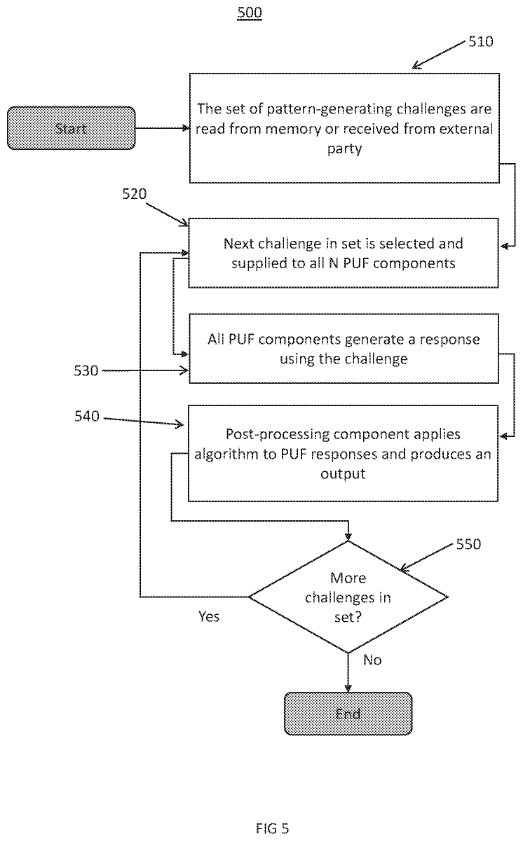

FIG. 5 illustrates a method of using a plurality of PUFs to generate an output which masks any response errors in the PUFs. The method 500 may be implemented by any suitable apparatus such as the apparatus 100 of FIG. 1, however it may be implemented by a different apparatus or device.

At 510, a set of pattern generating challenges are obtained, for example from a local or external memory comprising an enrolled set of challenges, or from an external party that may wish to authenticate a device which integrates the apparatus. The method 500 can be consider a recreating phase which complements the enrollment phase of method 400.

At 520, a first/next challenge from the enrolled set is selected and applied to all N PUF. For example, the enrolled set may comprise 256 challenges and these may be applied in any order to generate a 256 bit key. A new 256 bit key may be generated using a different order of these enrolled challenges. The order may be determined using a pseudorandom process.

At 530, all PUF components generate a response using the challenge. At 540, the method applies an algorithm to the PUF responses to produce an output. This may be implemented using post-processing circuitry which may also applies translations to one or more of the responses. The algorithm may be a majority or minority voting algorithm, with a minority voting algorithm simply being the inverse of the majority voting algorithm.

In an example, the pattern used when enrolling the challenge was all equal. When the challenge is used in the recreation mode, again the responses might be expected to be all equal however if an error in one of the responses occurs, the majority algorithm will still generate an output corresponding to each of the responses without an error. The majority algorithm effectively masks errors by some of the redundant PUF, up to (N−1)/2 errors. The minority algorithm may be used where an inverted response is used in some configurations. Similarly, some or all of the response may be translated in some way, for example by inverting. Other translations may include converting an analog measurement into a digital representation and/or translating bits into a hamming weight.

The output may be added to a register with a number of outputs used to generate a key or an identifier for example.

At 550, the method determines whether there are any more challenges to process. For example, if a register has not yet received all 256 output bits, the method returns to 520 to process the next challenge. If all challenges have been processed, the method stops.

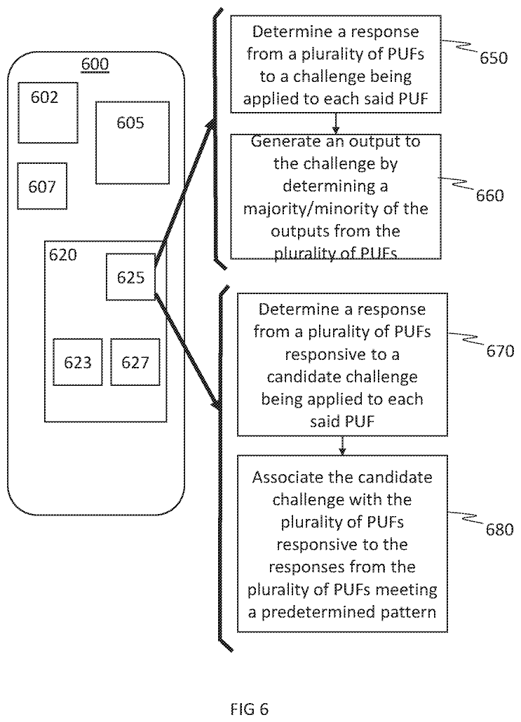

FIG. 6 illustrates an apparatus for providing security for a device according to an embodiment. The apparatus 600 may be incorporated into a communications device such as an IoT device. The apparatus comprises a processor 602, a communications interface 607, a plurality of PUFs 605 and a memory 620. The processor may implement some of the post-processing and/or pre-processing circuitry previously described. The memory may comprise processor readable instructions 625, an initial challenge set 623 and an enrolled challenge set 627. The processor-readable instructions, when executed by the processor 602, may cause the apparatus to operate as follows.

At 650, the apparatus is configured to determine a response from the plurality of PUFs to a challenge being applied to each said PUF. The challenge may be one of a predetermined set of challenges which have been previously enrolled for the apparatus.

At 660, the apparatus is configured to generate an output to the challenge by determining a majority (or minority) of the outputs from the plurality of PUFs. This corrects any errors that might have occurred in any of the redundant PUF.

At 670, the apparatus is configured for enrolment to determine a response output from a plurality of PUF responsive to a candidate challenge being applied to each PUF.

At 680, the apparatus is configured to associate the candidate challenge with the plurality of PUFs responsive to the responses from the plurality of PUFs meeting a predetermined pattern.

Embodiments may provide a number of advantages including a PUF based security apparatus without the need of expensive error correction and helper data storage with associated security risks of attacks on helper data mechanisms. For PUF's with large challenge-response pairs, helper data will likely be very large. The embodiments are also not dependent on PUF type, as any PUF's which takes multiple challenges are applicable. Also using PUFs of different types can be used to reduce the risk of common mode fault. PUF ageing is also less of a problem since a minority of PUFs failing does not affect the response values.

Whilst the embodiments have described with respect to providing a security apparatus for a communicating device such as an IoT device to enable cryptographic functions and device identifiers, other applications are also possible. For example, device authentication, securing a supply chain by verifying PUFs on each component (identifier for each chip), counterfeit detection. Also devices other than IoT devices may also employ embodiments such as phones and personal computers, services and other types of user device.

Modifications and other variants of the described embodiment(s) will come to mind to one skilled in the art having the benefit of the teachings presented in the foregoing descriptions and the associated drawings. Therefore, it is understood that the embodiment(s) is/are not limited to the specific examples disclosed and that modifications and other variants are intended to be included within the scope of this disclosure. Although specific terms may be employed herein, they are used in a generic and descriptive sense only and not for purposes of limitation.

1. A method of using physically unclonable functions, PUFs, the method comprising:
determining a response from each of a plurality of PUFs, to a set of predetermined challenges applied to each said PUF, the set of predetermined challenges including different challenges;
generating an output to each of the set of predetermined challenges using the responses from the plurality of PUFs and a majority or a minority decision algorithm.

2. The method of claim 1, wherein each said predetermined challenge is one of an enrolled set of challenges associated with the plurality of PUFs.

3. The method of claim 2, wherein the enrolled set of challenges is determined by:
determining a response from each of the plurality of PUFs responsive to a candidate challenge applied to each said PUF;
associating the candidate challenge with the plurality of PUFs responsive to the outputs from the plurality of PUFs meeting a predetermined pattern.

4. The method of claim 1, comprising determining a sequence of outputs in response to a sequence of predetermined challenges; and
using the sequence of outputs to perform one or more of the following: authenticate a device comprising the plurality of PUFs; generate a unique key associated with a device comprising the plurality of PUFs; generate an identifier for a device comprising the plurality of PUFs.

5-7. (canceled)

8. The method of claim 1, comprising translating the responses and performing a majority decision on the translated responses.

9. The method of claim 8, wherein the translating comprises inverting one or more responses.

10. The method of claim 1, comprising applying a sequence of challenges received from an external device and returning a corresponding sequence of outputs to the external device.

11. A method of using physically unclonable functions, PUFs, the method comprising:
determining a response from each of a plurality of PUFs responsive to a candidate challenge applied to each said PUF;
associating the candidate challenge with the plurality of PUFs responsive to the responses from the plurality of PUFs meeting a predetermined pattern.

12. The method of claim 11, wherein the predetermined pattern comprises all response values are the same or a predetermined number of predetermined responses

13. The method of claim 11, comprising applying a sequence of candidate challenges to the plurality of PUFs in order to associate a subset of the candidate challenges with the plurality of PUFs.

14. The method of claim 11, wherein the PUF of the plurality of PUFs comprise one or more types of PUF.

15. The method of claim 11, wherein an input to a said PUF comprises multiple bits and a response of a said PUF comprise a bit.

16-18. (canceled)

19. The method of claim 11, comprising determining a response from each of the plurality of PUFs for a pair of candidate challenges in which the respective outputs conflict;
and associating the pair of candidate challenges with the plurality of PUFs responsive to the response from the plurality of PUFs for each candidate challenge meeting the predetermined pattern.

20-30. (canceled)

31. An apparatus comprising a plurality of PUFs and circuitry configured to:
determine a response from each of a plurality of PUFs responsive to a candidate challenge applied to each said PUF;
associate the candidate challenge with the plurality of PUFs responsive to the response from the plurality of PUFs meeting a predetermined pattern.

32. The apparatus of claim 31, wherein the predetermined pattern comprises all response values are the same or a predetermined number of predetermined responses.

33. The apparatus of claim 31, the circuitry configured to apply a sequence of candidate challenges to the plurality of PUFs in order to associate a subset of the candidate challenges with the plurality of PUF.

34. The apparatus of claim 31, wherein the PUF of the plurality of PUFs comprise one or more types of PUF.

35. The apparatus of claim 31, wherein an input to a said PUF comprises multiple its and a response of a said PUF comprise a bit.

36-38. (canceled)

39. The apparatus of claim 31, the circuitry configured to determine a response from each of the plurality of PUFs for a pair of candidate challenges in which the respective responses conflict; and to associate the pair of candidate challenges with the plurality of PUF responsive to the outputs from the plurality of PUFs for each candidate challenge meeting the predetermined pattern.

40. The apparatus of claim 31, the circuitry configured to apply a sequence of challenges received from an external device and to return a set of challenges associated with the plurality of PUFs.

41-42. (canceled)
